(19) United States
(12) Patent Application Publication
(10) Pub. No.: US 2017/0291779 A1
(43) Pub. Date: Oct. 12, 2017

(54) DUST CONTROL IN PNEUMATIC PARTICULATE HANDLING APPLICATIONS

(71) Applicant: Halliburton Energy Services, Inc., Houston, TX (US)

(72) Inventors: Bryan Chapman Lucas, Duncan, OK (US); James Ray Troutman, Duncan, OK (US); Wesley John Warren, Marlow, OK (US); Calvin Lynn Stegemoeller, Duncan, OK (US); Chad Adam Fisher, Cache, OK (US)

(21) Appl. No.: 15/512,761

(22) PCT Filed: Nov. 14, 2014
(86) PCT No.: PCT/US2014/065668

§ 371 Date: Mar. 20, 2017

(51) Int. Cl. B65G 69/18; C09K 8/80; B01F 15/02; B01D 45/16; B01F 3/12; B01F 15/00

(52) U.S. Cl. CPC B65G 69/18; B01F 3/1228; B01F 3/1207; B01F 15/00961; B01F 15/0238; B01F 15/0235; B01F 15/0251; B01D 45/16; C09K 8/80; B01F 2015/0204

(57) ABSTRACT

In accordance with embodiments of the present disclosure, systems and methods for passively reducing or preventing dust formation in a particulate handling system are provided. In some embodiments, the handling system includes a silo for holding bulk material used to form a well fracturing treatment fluid. The silo may include a chute to deposit a portion of the bulk material from the silo into a blender and a cyclone mounted to the silo to separate dust from a pneumatic air flow and to release a substantially clean air into the atmosphere. In other embodiments, the handling system may include a horizontally oriented cyclone assembly mounted to a blender storage tank, cyclone assembly including a horizontally oriented cyclone separator to separate dust from a pneumatic airflow and a dust collection container to receive the dust and output the dust into the storage tank.

### TECHNICAL FIELD

The present disclosure relates generally to transferring particulate materials for well operations, and more particularly, to passive dust control in pneumatic particulate material fill systems and methods.

### BACKGROUND

During the drilling and completion of oil and gas wells, various wellbore treating fluids are used for a number of purposes. For example, high viscosity gels are used to create fractures in oil and gas bearing formations to increase production. High viscosity and high density gels are also used to maintain positive hydrostatic pressure in the well while limiting flow of well fluids into earth formations during installation of completion equipment. High viscosity fluids are used to flow sand into wells during gravel packing operations. The high viscosity fluids are normally produced by mixing dry powder and/or granular materials and agents with water at the well site as they are needed for the particular treatment. Systems for metering and mixing the various materials are normally portable, e.g., skid- or truck-mounted, since they are needed for only short periods of time at a well site.

The powder or granular treating material is normally transported to a well site in a commercial or common carrier tank truck. Once the tank truck and mixing system are at the well site, the dry powder material must be transferred or conveyed from the tank truck into a supply tank for metering into a blender as needed. The dry powder materials are usually transferred from the tank truck pneumatically. In the pneumatic conveying process, the air used for conveying must be vented from the storage tank and typically carries an undesirable amount of dust with it.

Attempts to control dust during the conveying process typically involve the rig up and use of auxiliary equipment, such as a dust collector and duct work, adding cost to the material handling operations. In addition, traditional material handling systems can have several transfer points between the outlets of multiple sand supply containers and a blender. These transfer points often have to be shrouded and ventilated to prevent an undesirable release of dust into the environment. Further, after the dust has been captured using the dust collectors and ventilation systems, additional steps are needed to dispose of the dust.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic above view of a system for transporting dry gel particulate at a well site, in accordance with an embodiment of the present disclosure;

FIG. 2 is a schematic view of a silo with a cyclone for removing dust, in accordance with an embodiment of the present disclosure;

FIG. 3 is a schematic view of an output chute of a silo feeding a blender hopper, in accordance with an embodiment of the present disclosure;

FIG. 4 is a cutaway view of a blender tank having a horizontal cyclone mounted on top of the tank, in accordance with an embodiment of the present disclosure; and

FIG. 5 is a partial perspective view of the horizontal cyclone of FIG. 4, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for reducing or eliminating dust in pneumatic particulate handling applications. Such particulate handling applications may include storing and moving dry material (e.g., proppant, gel particulate, or dry-gel particulate) during the formation of well fracturing treatment fluids. In such applications, the particulate is transferred as a bulk material between transportation units, storage tanks, blenders, and other components. The bulk material is often transferred pneumatically using pressurized air flows to provide the bulk material, for example, from a transportation unit to a silo or to a storage tank on a blender truck. The pneumatic transfer of this bulk material often generates an amount of dust in the pressurized air stream, and it is undesirable for this dust to be released into the atmosphere. Existing dust control techniques often utilize large pieces of additional equipment, separate power supplies, and complicated setups.

The dust control systems disclosed herein are designed to address and eliminate these shortcomings. Specifically, presently disclosed dust control systems may operate passively (without an additional power supply) and without any cumbersome equipment setup, in order to provide dust control throughout the formation of well treatment fluid from pneumatically transported bulk particulate. In some embodiments, the dust control system may include a cyclone disposed atop a vertically oriented silo designed to store the bulk material prior to blending. The cyclone may passively separate dust from the air stream used to pneumatically carry the bulk material into the silo. A dust collection container coupled to the cyclone may release the dust onto the bulk material stored in the silo, thereby keeping the dust self-contained. In addition, the silo may be configured to discharge the bulk material directly into a blender hopper of a blender machine, without using intermediate transfer points that tend to release dust into the air. In some embodiments, the silo may include a discharge chute designed so that the bulk material can be discharged from the silo into the blender hopper without a vertical drop that tends to release dust into the air. Accordingly, embodiments of the present disclosure may be directed to a bulk material storage and transfer system that provides passive (non-powered) dust control both while the silo is being filled and while the silo is discharged.

In other embodiments, a storage tank on a blender truck, or some other vehicle, may include a horizontally oriented passive cyclone disposed thereon to separate dust from an air stream used to pneumatically fill the storage tank. The cyclone deposits collected dust into the storage tank once it is filled. The horizontal orientation of the cyclone may enable the cyclone to more easily and simply deposit the collected dust onto the bulk material in the storage tank, while maintaining the total height of the storage tank and truck under a legal road height limit. Other systems may also be utilized to reduce or eliminate the dust released into the atmosphere at a well site where the well treatment fluid is being generated.

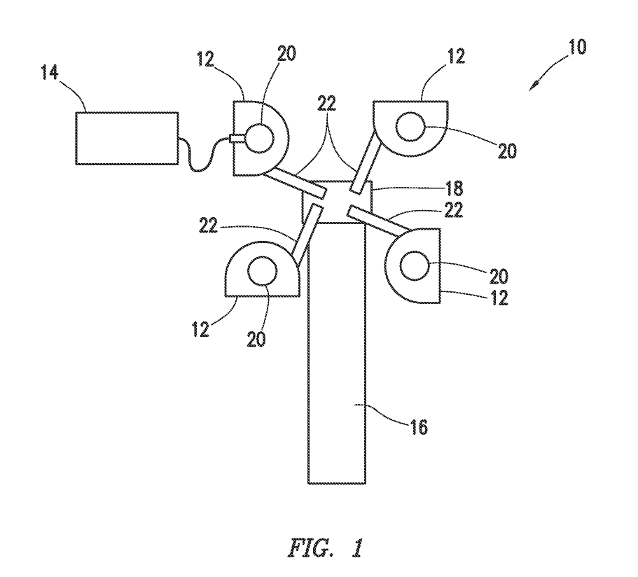

Turning now to the drawings, FIG. 1 is an above schematic view of a system 10 for handling, storing, and transporting a bulk material at a well site. As mentioned above, the bulk material may include a dry material (e.g., proppant, gel particulate, or dry-gel particulate) that can be blended into a fluid for treating a wellbore. The fluid may be pumped into the wellbore during a fracturing treatment in order to create or enhance fractures formed through a downhole formation adjacent the wellbore.

Before the prepared fracturing treatment fluid is provided to the wellbore, the system 10 may facilitate storage, blending, and preparation of the bulk material for use in the treatment fluid. In the illustrated embodiment, the system 10 includes four silos 12 disposed proximate one another. The silos 12 are used to store the bulk material before the material is blended into a well treatment fluid. The system also includes a transportation unit 14 that may be used to transport the bulk material to the wellsite, where the bulk material may then be stored in the silos 12. As illustrated, the transportation unit 14 may transfer the bulk material into one or more of the silos 12 via a flexible hose connection. In presently disclosed embodiments, the transportation unit 14 transfers the bulk material into the storage silo 12 pneumatically. That is, the transportation unit 14 utilizes pressurized air to carry the bulk material from the portable storage tank of the transportation unit 14 to the silo 12.

The system 10 may also include a blender 16, which in the illustrated embodiment is disposed between the silos 12. The blender 16 may be a truck or skid mounted system that receives bulk material from the silos 12 and blends the bulk material with water or other fluids and elements to produce the desired well treatment fluid. The blender 16 may include a hopper 18 at one end. The hopper 18 may include a trough designed to receive the bulk material from one or more of the silos 12.

In the illustrated embodiment, each of the silos 12 may include a cyclone separator 20 disposed thereon. Each cyclone separator 20 may be disposed along or near an upper surface of the corresponding silo 12. However, in other embodiments, the cyclone separator 20 may be positioned proximate the silo 12 at a position along a vent line (e.g., flexible hose) used to transport the pneumatic airflow from the transportation unit 14 to the silo 12. The silo 12, transportation unit 14, and flexible hose may be designed to provide the bulk material into the silo 12 via pressurized air and then to divert the pressurized air into the cyclone 20. From here, the cyclone 20 may separate any remaining dust particles from the pressurized air stream before rejecting substantially clean air into the atmosphere. The cyclone 20 may be a passive separator that operates via the pressurized air flow, not via a separate power supply.

In addition to the cyclones 20, the silos 12 may include discharge chutes 22 extending away from the silos 12 and directly into the hopper 18 of the blender truck 16. The blender 16 may be driven and parked between the silos 12 such that all the discharge chutes 22 extending from the different silos 12 may converge within the hopper 18. Thus, the silos 12 are able to discharge sand or other bulk material directly into the hopper 18 of the blender 16 using the chutes 22 only and no intermediate points. Intermediate points are often used in traditional bulk material handling systems, and conveying the bulk material across intermediate points can release undesirable dust into the air. Accordingly, such systems are generally supplemented with shrouding or ventilation components to remove the dust from the air around the intermediate points. However, the disclosed embodiment illustrated in FIG. 1 does not utilize intermediate points at all, but merely releases the stored bulk material from the silos 12 into the blender hopper 18 via the chutes 22 extending therefrom.

As illustrated, the silos 12 may be oriented vertically in order to accommodate this improved arrangement of the chutes 22 extending from the silos 12 toward the same hopper 18. In other words, each silo 12 may be positioned such that the longest dimension of the silo 12 is oriented substantially parallel to a direction of gravity. The vertically oriented silos 12 may also feature at least partially rounded horizontal cross sections. For example, the illustrated silos 12 include semi-circular cross sections. These rounded cross sections may help the silos 12 to handle a relatively higher pressurization inside the silos 12 as compared to silos that have a prismatic cross section. This slight pressurization within the silos 12 may enable the corresponding cyclones 20 to operate effectively.

As described above, the cyclone separators 20 coupled to the vertically oriented silos 12 may reduce an amount of dust released into the atmosphere while transferring bulk material from the transportation unit 14 to the silos 12. Additionally, the silos 12 being arranged in close proximity and having chutes that each extend into the same hopper 18 of the blender 16 (without intermediate points) may reduce an amount of dust released into the air while transferring the bulk material from the silos 12 to the blender 16. Accordingly, the vertically oriented silos 12 having the cyclone separators 20 attached and having the chutes 22 extending toward the hopper 18 of the blender 16 may work together to facilitate a transfer of bulk material through the system 10 while minimizing the amount of dust released. The system components may work together to facilitate this transfer of materials without the use of separately powered vacuum dust collectors, ductwork, or shrouding that are used in traditional systems.

It should be noted that other types of bulk material handling systems may utilize the techniques disclosed herein. That is, the bulk material handling system shown in FIG. 1 should not be seen as limited to the field of bulk material handling for wellbore applications. The disclosed techniques may be used for any free-flowing granular materials that are transported through a vertical silo via pneumatic filling.

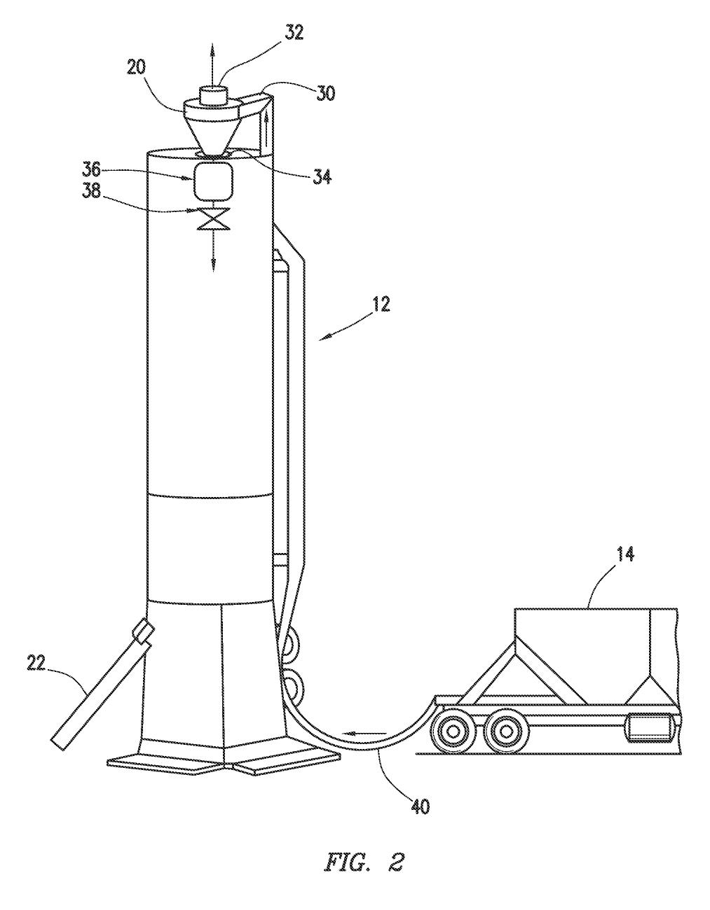

Having now generally discussed the overall bulk material handling system 10 of FIG. 1, a more detailed description of the cyclone separator 20 used in the system 10 will be provided. To that end, FIG. 2 illustrates a detailed view of one of the silos 12 described above, including the cyclone 20 disposed thereon.

The cyclone separator 20 is installed on the silo 12 to capture dust during pneumatic filling of the silo 12. The cyclone 20 generally includes a funnel with one inlet 30 (e.g., on the side) and two outlets 32 and 34 (one at the top and one at the bottom). When pressurized air with dust particles flows into the cyclone 20 through the inlet 30, the air may form a vortex within the cyclone, spiraling downward and then up and out of the cyclone 20 via the first outlet 32. However, the dust particles may hit an inside wall of the cyclone 20 because of their higher mass and inertia, and the impact on the wall may cause the dust particles to fall through the cyclone 20 and out through the second outlet 34. As illustrated, the cyclone 20 may be located directly above the silo 12 so that the dust discharged from the cyclone 20 can fall back into the silo 12. In some embodiments, the cyclone 20 may be at least partially disposed within an upper portion of the silo 12.

In addition to the cyclone 20, the silo 12 may also include a dust collection container 36, which in the illustrated embodiment is disposed inside the silo 12. The dust collection container 36 is coupled to the cyclone 20 so that it may receive the dust separated from the flow of air by the cyclone 20 and deposit the dust into the silo 12 on top of the bulk material. In addition, a valve 38 may be disposed in the silo 12 and coupled to the dust collection container 36 in order to enable capture and later release of the dust within the dust collection container 36. For example, the valve 38 may be closeable such that, when the valve 38 is closed, the dust collection container 36 retains the dust filtered through the cyclone 20. When the valve 38 is opened, gravity may force the dust to fall out of the collection container 36, through the valve 38, and into the silo 12. In some embodiments, the valve 38 may include a rotary lock valve that allows dust to continually fall from the dust collection container 36 into the silo 12 without opening the dust collection container 36 to the pressure within the silo 12.

In operation, the bulk material (e.g., proppant) is pneumatically blown from the transportation unit 14, through a flexible conduit 40, and into the silo 12. Most of the bulk material may fall into the silo 12 while residual dust travels with the air through the inlet 30 into the cyclone 20. From here, the cyclone 20 may discharge substantially clean air through the first outlet 32 into the atmosphere. The cyclone 20 may allow the dust to fall through the second outlet 34 and collect in the dust collection container 36 (e.g., hopper). The valve 38 may enable the capture and subsequent release of the dust particles from the dust collection container 36. In some embodiments, the dust collection container 36 may empty into the silo 12 after the pneumatic loading is completed. In embodiments where the valve 38 is a rotary lock valve, the dust collection container 36 may empty into the silo 12 more frequently (e.g., during pneumatic filling).

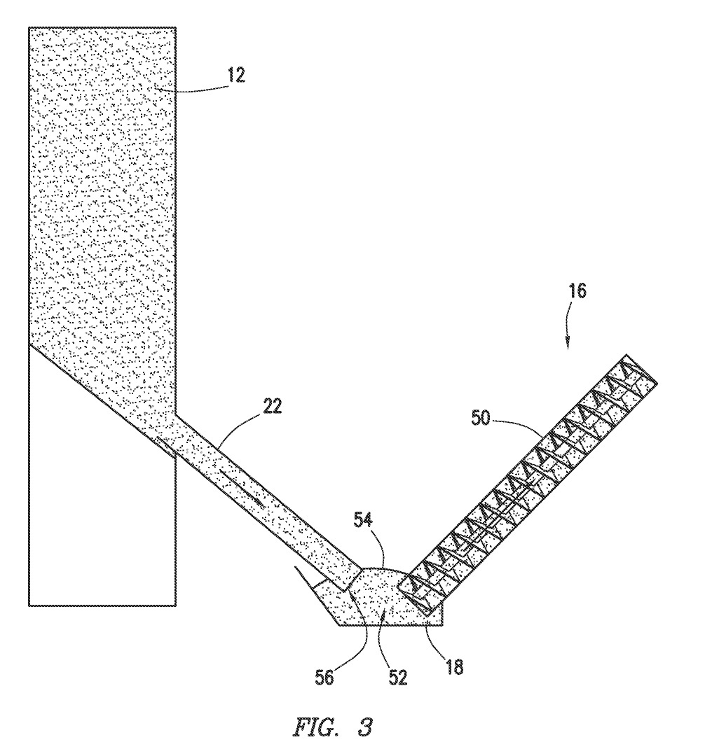

FIG. 3 illustrates the interface between the chute 22 extending from the silo 12 and certain components of the blender 16. As illustrated, the blender 16 may include an auger 50 or sand screw designed to move bulk material 52 from the blender hopper 18 into a blending tank (not shown) of the blender 16. Thus, instead of pneumatically moving the bulk material 52 from the hopper 18 into the blender tank, the blender 16 may utilize a mechanical conveying element to transport the bulk material 52 into the blender tank. Rotation of the auger 50 may be controlled to transport the bulk material 52 into the blender tank in a metered fashion, in order to maintain a desired ratio of the bulk material rate to fluid rate entering the blender tank. It should be noted that other mechanical conveying devices (e.g., conveyor belts, etc.) may be used in other embodiments to deliver the bulk material in a metered fashion to the blender tank.

The silo discharge chute 22 may be designed for a choke feed in present embodiments. That is, the chute 22 may extend from the silo 12 such that additional bulk material is discharged from the chute 22 at a fill level 54 of the bulk material 52 already present in the hopper 18. In some embodiments, the silo 12 may be entirely filled with bulk material after the pneumatic filling is performed. From here, an outlet valve (not shown) at a top of the chute 22 may be opened and kept open while the chute 22 fills the blender hopper 18. The bulk material may travel down the chute 22 and be discharged into the hopper 18 under a force due to gravity working on the bulk material. An angle of repose of the bulk material 52 in the hopper 18 may affect the flow rate of material from the chute 22.

As the auger 50, or other mechanical conveyance system, removes the bulk material 52 from the hopper 18 at a metered rate, additional bulk material may flow from the chute 22 to replace the fill level 54 in the hopper 18. When the auger 50 stops, the bulk material 52 may build a pile with the edges defined by the material's angle of repose. When the bulk material fill level 54 reaches an outlet end 56 of the chute 22 at the angle of repose, the bulk material 52 may plug the chute 22 and prevent additional material from flowing out of the silo 12. As the delivery rate of the auger 50 may be less than the rate of discharge of the bulk material from the chute 22 due to gravity, the fill level 54 of the bulk material 52 in the hopper 18 may be maintained at relatively near the outlet end of the chute 22.

As a result of the choke feed provided through the arrangement of the chute 22 relative to the blender hopper 18, bulk material may move from the silo 12 down the chute 22 and into the hopper 18 without undergoing a vertical drop through the air. Existing systems used to move bulk material from a storage silo to a hopper often include a vertical drop from a silo chute outlet to a sand pile in the hopper or along a conveyor. Such vertical drops can release undesired dust particles of the bulk material into the air. However, unlike these traditional systems, the illustrated embodiment of the chute 22 and the blender hopper 18 may maintain the fill level 54 of the bulk material 52 high enough so that the material particles pass through no, or a very small, vertical drop through air between the chute 22 and the bulk material pile in the hopper 18. In some embodiments, the auger 50 may be wetted with water or other fluids so that the auger 50 may wet the bulk material 52 being transported up the auger 50. This may prevent or reduce dust from entering the atmosphere as the auger 50 transports the bulk material to the blender tank.

As discussed above, several different passive dust control components may be used to reduce or prevent dust from entering the atmosphere while the bulk material is transported between certain wellsite equipment. Such features (e.g., cyclone 20, chute 22 directly emptying into the hopper 18, and choke feed at the chute 22) may facilitate effective dust control at the bulk material handling site without the use of ventilation or other components that use a separate power source. In addition, since the cyclone 20 recycles the dust back into the silo 12 and the chutes 22 dispose the bulk material directly into the hopper 18 without a vertical drop, there is no need for a separate dust collector. Dust collectors are sometimes used in existing systems to capture dust that is released from the system components, keeping the dust separate from the bulk material being processed. By eliminating the need for such dust collectors, the disclosed system 10 reduces the cost associated with equipment transportation, rig up, and operation of a dust collector trailer. Furthermore, since the dust is recycled in the disclosed system 10, there is no dust waste stream that would eventually have to be emptied. Still further, when combined with wetting sand at the blender auger 50, a completely passive dust control system may be implemented at well fracturing sites.

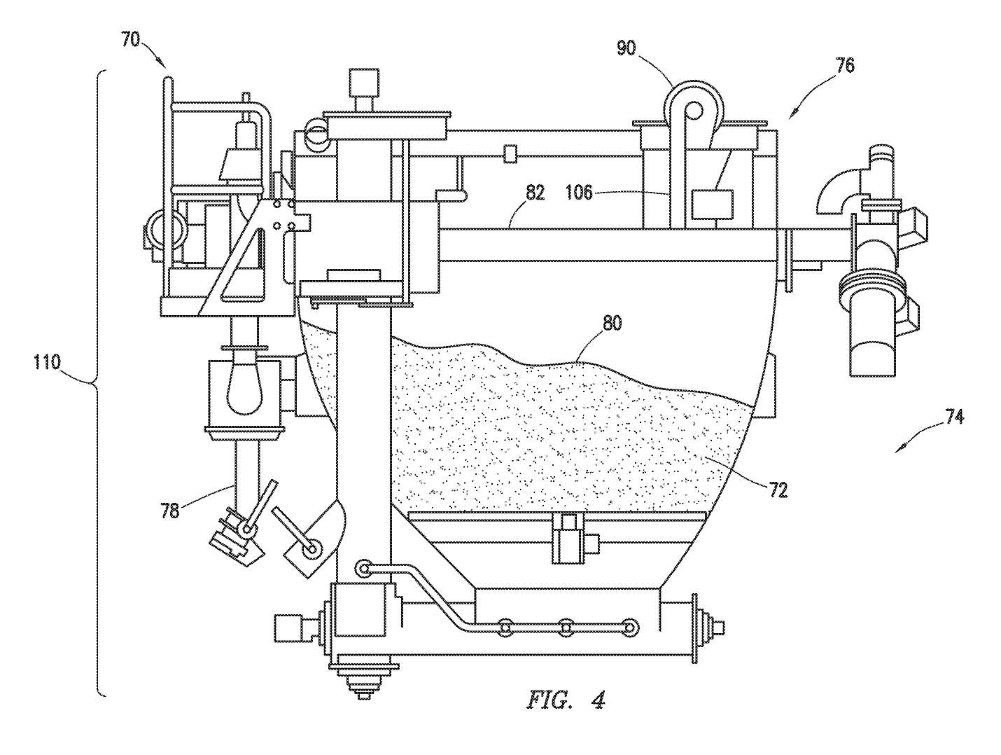

In some embodiments of bulk material transportation systems, the bulk material may be pneumatically carried directly into a blender storage tank, instead of a silo. One such bulk material transportation system 70 is illustrated in FIG. 4. The system 70 includes a storage tank 72 disposed on a blender 74. The blender 74 may include additional elements (not shown) for transferring bulk material from the storage tank 72 into a blend tank so that the bulk material may be blended with other fluids to produce a well fracturing treatment fluid. In some embodiments, the blender 74 may be a portable system that is built onto a trailer, and the illustrated storage tank 72 may be disposed at one end of the blender trailer.

The system 70 also includes a horizontally mounted cyclone separator assembly 76 disposed proximate a top of the storage tank 72. The cyclone assembly 76 may be disposed just outside and mounted to the storage tank 72 in some embodiments. In other embodiments, the cyclone assembly 76 may be at least partially disposed within the storage tank 72.

To generate the desired well treatment fluid, the bulk material (e.g., proppant, gel, or dry-gel particulate) may be pneumatically directed into the storage tank 72 through an inlet 78 at one side of the storage tank 72. The bulk material may be blown through the inlet 78 and into the storage tank 72, where the bulk material accumulates as indicated by a fill level 80. The pressurized air, which may be dirty from carrying dust particles of the bulk material, can then be routed out of the storage tank 72 through the horizontal cyclone assembly 76, and the cyclone assembly 76 may separate the dust from the air stream, releasing substantially clean air into the atmosphere and dropping the dust particles into the storage tank 72 on top of the bulk material.

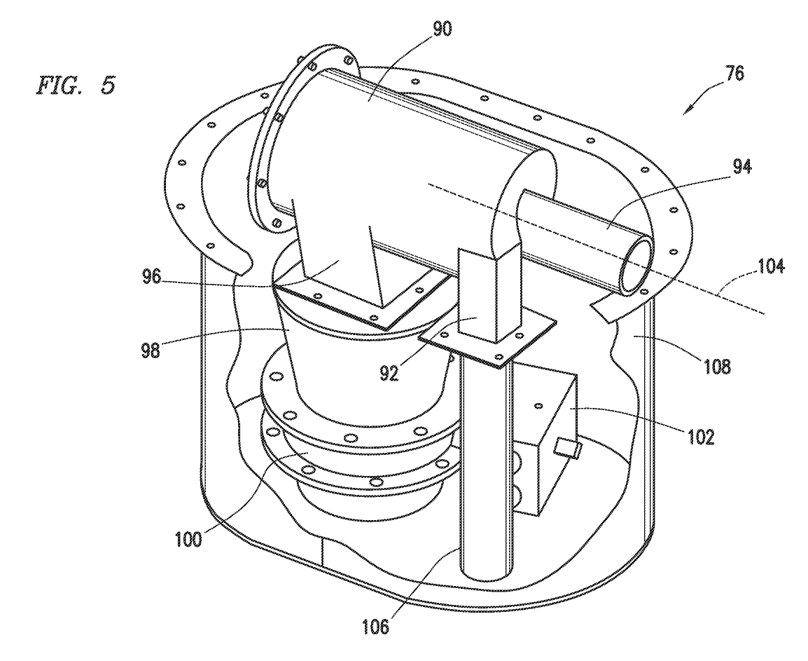

Having now generally discussed the operation of certain components of the storage tank 72, a more detailed description of the horizontal cyclone assembly 76 will be provided. To that end, FIG. 5 provides a detailed view of the various internal components of the horizontal cyclone assembly 76. The illustrated cyclone assembly 76 may include a horizontally oriented cyclone separator 90 having a single air inlet 92, a first outlet 94 that functions as a clean air discharge, and a second outlet 96 for the dust separated from the clean air. In addition, the cyclone assembly 76 may include a dust collection hopper 98 coupled to the second outlet 96, a valve 100 disposed at an end of the dust collection hopper 98 to selectively release collected dust into the storage tank, and a hydraulic actuator 102 coupled to and designed to actuate the valve 100.

The horizontal cyclone separator 90 may be installed on the storage tank 72 to capture dust during pneumatic filling of the storage tank 72. The cyclone 90 may generally include a cylindrical or conical funnel with the one inlet 92 (e.g., on the bottom) and two outlets 94 and 96 (one at the side and one at the bottom). The cyclone 90 is generally oriented horizontally, meaning that an axis 104 of the cylindrical or conical portion of the cyclone 90 is substantially aligned with a horizontal plane and perpendicular to a direction of gravity when the cyclone 90 is installed on the storage tank 72. In some embodiments, the horizontal cyclone 90 may include an off-the-shelf unit that may be mounted to the storage tank 72. The cyclone assembly 76 may also include a conduit 106 designed to route dust and pressurized air from the storage tank 72 into the inlet 92 of the cyclone 90. In some embodiments, the cyclone assembly 76 may also include a housing 108 for containing and protecting the components packaged into the cyclone assembly 76. The housing 108 may also function to separate certain control components of the cyclone assembly 76 from the contents of the storage tank 72.

When pressurized air with dust particles flows into the cyclone 90 through the inlet 92, the air may form a vortex within the cyclone, spiraling out of the cyclone 90 via the first outlet 94. However, the dust particles may hit an inside wall of the cyclone 90 because of their higher mass and inertia, and the impact on the wall may cause the dust particles to fall through the cyclone 90 and out through the second outlet 96. As illustrated in FIG. 4, the cyclone 90 may be located directly above or proximate an upper portion of the storage tank 72 so that the dust discharged from the cyclone 90 can fall back into the storage tank 72.

As shown in FIG. 5, the collection hopper 98 is disposed below the cyclone 90 and is generally used to capture and contain the dust that is separated from the airflow via the cyclone 90 and released through the second outlet 96. The collection hopper 98 may be sealed off from the pressurized air that is used to pneumatically convey the bulk material into the storage tank 72, and this allows the cyclone 90 to operate effectively. The sealing action may be accomplished through the use of the valve 100.

In some embodiments, the valve 100 may include a butterfly valve, although other types of valves may be used in other embodiments. For example, as described below, the valve 100 may be a rotary lock valve in some embodiments. The valve 100 may be actuated via hydraulic power provided from the hydraulic actuator 102. It should be noted that other types of actuation mechanisms other than hydraulics may be used to actuate the valve 100 in other embodiments, such as air powered or mechanical actuators. Once the storage tank 72 has been pneumatically filled with bulk material, the valve 100 may be opened, discharging the collected dust material from the collection hopper 98 onto the top of the pile of bulk material that was just blown into the storage tank 72.

In some embodiments of the system 70, another isolation valve may be used to selectively close the inlet 78 of the pneumatic fill line used to direct the pressurized air and bulk material into the storage tank 72. In existing systems, a valve in this position may be manually opened to pneumatically fill the storage tank and closed to stop filling the tank. Similarly, in existing systems, collection hopper valves are generally operated manually as well, thereby relying on accurate human operation of both valves to perform successful filling of the storage tank and disposal of dust into the tank. If these valves are not operated properly, the cyclone may not work as desired (e.g., when the inlet valve is left open), or may slowly fill up with dust and stop working (e.g., when the dust collection valve is not opened).

In the disclosed embodiment, however, the valve at the inlet 78 may be actuated via hydraulic power. In addition, this valve may be automated and set up to cycle opposite the isolation valve 100 located at the collection hopper 98. In some embodiments, a controller may be communicatively coupled to the inlet valve and to the discharge valve 100, and the controller may actuate the inlet valve and the discharge valve so that the valve 100 is open when the inlet valve is closed and the inlet valve is open when the valve 100 is closed. This would allow the system 70 to automatically discharge all of the collected dust back into the storage tank 72 (by opening valve 100) only when the pneumatic airflow has been stopped (by closing the valve on the inlet 78). In this way, the system 70 may be controlled to take any guesswork out of the pneumatic filling and dust disposal operations within the storage tank 72.

In addition to improving the control of the storage tank filling and other operations of the system 70, the horizontally oriented cyclone assembly 76 may provide certain advantages due to the height difference of the horizontally oriented cyclone 90 as compared with a vertically oriented cyclone. First, the horizontally oriented cyclone 90 may be mounted on or proximate an upper surface of the storage tank 72, or external to the storage tank 72, while maintaining a desired overall height of the entire blender 74. As mentioned above, the storage tank 72 may form part of a blender trailer that is designed to be transported over roads or other areas with maximum height limitations. The horizontal cyclone 90 may enable the passive separation of dust from an air stream while keeping an overall height 110 of the blender 74 beneath this height limit (e.g., 13 feet, 6 inches).

Still further, the horizontally oriented cyclone 90 may facilitate a more space efficient arrangement of the cyclone assembly 76 relative to the bulk material in the storage tank 72. More specifically, the horizontally oriented cyclone assembly 76 may be positioned high enough above or within the storage tank 72 that the bottom edge of the cyclone assembly 76 remains entirely above the fill level 80 of the bulk material in the storage tank 72. As illustrated in FIG. 4, the cyclone assembly 76 may be arranged relative to the other components of the system 70 to further keep the bottom of the cyclone assembly 76 away from the fill level 80. That is, the cyclone assembly 76 may be disposed at an end of the storage tank 72 opposite the end in which the bulk material is pneumatically blown in through the inlet 78. In addition, in some embodiments, a conveying mechanism (e.g., discharge auger, conveyor belt, etc.) may be used to move the bulk material out of the storage tank 72 in a metered fashion to another section of the blender 74. This conveying mechanism may be positioned at the same end as the cyclone assembly 76, so that the bulk material is constantly being taken from that end. These arrangements may facilitate a sloped fill level 80 that is generally lower at the end near the cyclone assembly 76 and higher toward the inlet 78. This sloped fill level 80 may allow the cyclone assembly 76 to utilize a collection hopper 98 that is relatively larger and extends further into the storage tank 72 to hold the dust collected from the cyclone 90.

In some embodiments, the collection hopper 98 may not be large enough to hold an entire filling cycle worth of dust separated by the cyclone 90 and to remain high enough above the fill level 80. In such instances, the valve 100 of the cyclone assembly 76 may include a rotary lock valve. The rotary lock valve may enable the collection hopper 98 to empty the collected dust into the storage tank multiple times throughout a single pneumatic filling cycle, without allowing high pressured air to reach the cyclone 90 from the collection hopper 98. Similar effects may be accomplished through the use of two valves instead of just one at the discharge of the collection hopper 98, among other automated valving arrangements.

It is desirable to maintain the bottom of the collection hopper 98 at a higher position than the fill level 80 in the storage tank 72, since otherwise the collected dust would have to be physically removed from the collection hopper 98 in ways other than relying on gravity. Existing systems sometimes use a vertical cyclone that is mounted inside the storage tank so that the entire system conforms to height limitations. In these systems, however, the collected dust must be physically evacuated from the collection hopper that is buried in the bulk material within the tank. For example, these systems often utilize vacuum pumps or a pneumatic diaphragm pump to physically remove the dust from a collection hopper that is buried beneath the bulk material in a storage tank. However, the disclosed horizontally oriented cyclone assembly 90 allows the system 70 to operate effectively and reduce dust without the use of additional components like vacuum or diaphragm systems, which can be expensive. Instead, the cyclone assembly 90 is oriented so that it is always above the fill level 80 and can empty the collection hopper 98 via gravity.

In existing systems that do not use these auxiliary pumps, an operator generally waits until the fill level in the storage tank dips below the bottom of the hopper before releasing the dust into the tank. However, such manual operations can be difficult since they rely on a human operator to remember which valves have been opened or closed and to carefully track a fill level of the tank, all without being able to see inside the storage tank. Additionally, such manual valve operations often rely on a gearbox, which can sometimes be stripped without an operator's knowledge. This sort of watching and waiting for the fill level 80 to go down is not necessary with the disclosed system 70, since the cyclone assembly 90 is always located above the fill level 80. Thus, the disclosed system 70 may reduce the complexity of storage tank filling operations, increase the accuracy of the process by automating the valve controls, and increasing the efficiency of the pneumatic filling and dust collection operations.

In systems where the valve to release the captured dust is hydraulically operated, as in the disclosed embodiments, it is important that the valve 100 and hydraulic lines leading to the valve 100 are maintained above the fill level 80, so that the hydraulic fluid does not accidentally come into contact with and contaminate the bulk material in the storage tank 72. Such hydraulic leaks would otherwise be difficult for an operator to detect inside the storage tank 72. The disclosed cyclone assembly 76 may include all the hydraulic control lines and the actuator 102 disposed inside the housing 108 of the assembly, thereby keeping the hydraulic fluid completely separate from the bulk material inside the storage tank 72. In some embodiments, the entire cyclone assembly 76, including the hydraulic components, may be disposed external to the storage tank 72 in order to prevent hydraulic fluid from contaminating the bulk material.

The disclosed system 70 having the horizontally oriented cyclone assembly 76 may enable relatively passive dust control during a process of pneumatically filling a blender tank. The disclosed system 70 may allow for collected dust from the cyclone 90 to be discharged from the collection hopper 98 to the top of the pile of bulk material that was just pneumatically blown into the storage tank 72, thereby recycling all the dust from the pneumatic filling process.

Although the present disclosure and its advantages have been described in detail, it should be understood that various changes, substitutions and alterations can be made herein without departing from the spirit and scope of the disclosure as defined by the following claims.

What is claimed is:

1. A system, comprising:
a silo for holding bulk material;
a discharge chute disposed at a lower portion of the silo; and
a cyclone disposed proximate the silo in order to separate dust from a flow of air used to pneumatically carry the bulk material into the silo.

2. The system of claim 1, wherein the cyclone is mounted to the silo at a position above a level of the bulk material in the silo.

3. The system of claim 2, further comprising a dust collection container disposed in the silo and coupled to the cyclone to receive the dust separated from the flow of air by the cyclone and deposit the dust into the silo.

4. The system of claim 3, further comprising a valve disposed in the silo and coupled to a lower portion of the dust collection container, wherein the valve controls deposition of the dust from the dust collection container into the silo.

5. The system of claim 2, further comprising a rotary air lock valve disposed in the silo and coupled to the cyclone to deposit dust separated from the flow of air by the cyclone into the silo.

6. The system of claim 1, wherein the cyclone is installed along a vent line used to direct the flow of air with the bulk material into the silo.

7. The system of claim 1, wherein the silo comprises a substantially rounded horizontal cross section.

8. The system of claim 1, wherein the discharge chute outputs a portion of the bulk material directly into a hopper of the blender at a rate based on a force due to gravity acting on the bulk material.

9. A method, comprising:
pneumatically delivering a bulk material into a silo via a flow of air;
receiving the flow of air at a cyclone disposed proximate the silo; and
separating dust from the flow of air via the cyclone.

10. The method of claim 9, further comprising collecting the dust in the silo with the bulk material.

11. The method of claim 9, further comprising:
delivering a portion of the bulk material away from the silo via a chute extending from the silo;
receiving the bulk material into a blender via a hopper of the blender positioned proximate a lower end of the chute; and
blending the bulk material into a well fracturing treatment fluid via the blender.

12. The method of claim 11, further comprising:
pneumatically delivering a bulk material into multiple silos via multiple flows of air directed to the corresponding silos;
delivering portions of the bulk material away from the multiple silos and into the hopper of the blender via chutes extending from the respective silos directly into the hopper; and
blending the bulk material received from the multiple silos via the blender.

13. The method of claim 11, further comprising:
transporting the bulk material from the hopper into a blending tank of the blender via a mechanical conveying device of the blender; and
wetting the bulk material at the auger to prevent dust from entering the atmosphere as the mechanical conveying device transports the bulk material.

14. A system, comprising:
a storage tank coupled to a blender and comprising an inlet to receive an air flow used to pneumatically carry bulk material into the storage tank; and
a cyclone assembly positioned to receive the air flow from the inlet, the cyclone assembly comprising:
a cyclone separator that is oriented along a horizontal axis, the horizontal axis being substantially perpendicular to a direction of gravity, wherein the cyclone separator comprises a first outlet to vent substantially clean air to the atmosphere and a second outlet to discharge the dust; and
a discharge valve coupled to the second outlet of the cyclone separator to output the dust separated from the air flow into the storage tank.

15. The system of claim 14, wherein the cyclone separator further comprises a dust collection container coupled to the second outlet of the cyclone separator to receive the dust separated from the air flow, and wherein the discharge valve is disposed at a lower end of the dust collection container to open the dust collection container to the storage tank.

16. The system of claim 14, wherein the discharge valve comprises a rotary air lock that discharges dust into the bulk tank.

17. The system of claim 14, further comprising:
an inlet valve disposed proximate the inlet to the storage tank, wherein the valve allows the pneumatically directed bulk material to flow into the inlet when the valve is open; and
a controller communicatively coupled to the inlet valve and to the discharge valve, wherein the controller actuates the inlet valve and the discharge valve such that the discharge valve is open when the inlet valve is closed and the inlet valve is open when the discharge valve is closed.

18. The system of claim 14, wherein a bottom surface of the discharge valve is maintained above a fill level of the bulk material in the storage tank throughout filling of the storage tank.

19. The system of claim 14, wherein the cyclone assembly is entirely disposed above and coupled to the storage tank.

20. The system of claim 14, wherein the storage tank and the cyclone assembly are part of a truck mounted system with a maximum height that is less than a standard maximum legal road height.
